(19) United States
(12) Patent Application Publication
(10) Pub. No.: US 2008/0281492 A1
(43) Pub. Date: Nov. 13, 2008

(54) Method and Device For Estimating at Least One Characteristic

(76) Inventor: Marc Theisen, Besigheim (DE)

Correspondence Address: KENYON & KENYON LLP, ONE BROADWAY, NEW YORK, NY, 10004, US

(21) Appl. No.: 11/885,841

(22) PCT Filed: Jan. 24, 2006
(86) PCT No.: PCT/EP2006/050390

§ 371 Date: May 13, 2008

(30) Foreign Application Priority Data
Mar. 11, 2005 (DE) 102005011244.7

(51) Int. Cl. G06F 19/00

(52) U.S. Cl. 701/45

(57) ABSTRACT

A method and device for estimating at least one characteristic which is derived from at least one base characteristic and which is evaluated for the generation of a triggering signal for a passenger protection device, a contact time is calculated at a first time after an impact has occurred, the curve of the at least one derived characteristic being ascertained in retrospect in a time span between the calculated contact time and the first time.

### FIELD OF THE INVENTION

The present invention relates to a method and device for estimating at least one characteristic.

### BACKGROUND INFORMATION

In the case of passenger protection systems, when decisions are to be made about the triggering of passenger protection means, a time is calculated at which a contact with, or an impact of one's own vehicle on another object has taken place. The point in time of the contact or the impact is also designated below as actual contact time. The point in time ascertained by calculation is designated as the calculated contact time. The calculated contact time may differ from the actual contact time, for instance, because of measuring tolerances.

In conventional methods, the calculated contact time is established by a point in time at which at least one specified condition is satisfied. Such a condition may be, for example, that, an acceleration signal or a first or second window integral exceeds a specified value. For this case, a point in time at which the contact time is calculated, and the calculated contact point agree. Beginning at the calculated contact point, at least one characteristic is then calculated or derived, which is based on at least one sensor signal. In this manner of calculating, the period of time between the actual contact time and the calculated contact time is not taken into consideration for the calculation of the characteristics.

Moreover, conventional methods for the backward calculation of the contact time are available. In these cases, it is ascertained at an actual point in time how far back the contact time is. Using such methods, one is able to ascertain the actual contact time more accurately.

### SUMMARY

An example method according to the present invention for estimating at least one characteristic may have the advantage that, after an impact has taken place, at a first point in time, a theoretical contact point is calculated, and the curve of the at least one derived characteristic in a period of time between the calculated contact time and the first point in time, at which the contact time is calculated, is ascertained after the event. Thereby, for the triggering decision of the passenger protection device, the curve of the characteristic can be taken into consideration as of a point in time which is closer to the actual contact time than in the conventional methods, or agrees with the actual contact time.

The consideration of the estimated characteristic curve, as of an earlier point in time, makes it possible, in an advantageous manner, to reach a more reliable decision in generating a triggering signal for a subsequent method, and to avoid unnecessary false triggering. This ensures optimal protection of the passengers, at simultaneous minimization of costs which can be created by an undesired triggering of the passenger protection device. Starting from available sensor signals, and taking into account the estimated characteristic curve, an example method according to the present invention decides, in an advantageous manner, between the calculated contact time and the time of the calculation of the contact time, whether, in the present situation, after a detected collision with an object, a triggering or an activation of the passenger protection device is required or not.

An example device according to the present invention for evaluating at least one characteristic includes an arrangement for carrying out the example method according to the present invention for estimating at least one characteristic.

It may be of particular advantage if a value of the at least one base characteristic is taken into consideration at the first point in time, for the estimation of the at least one characteristic curve. This may make possible a simple and rapid implementation of the example method according to the present invention.

The characteristic curve can be approximated, for example, starting from the value of the at least one base characteristic at the first point in time by using a parabola that is drawn through the calculated contact times and the first point in time.

Additional values of the at least one base characteristic, for instance, scanning values of the at least one base characteristic, from a specified, elapsed time period, can be taken into consideration for the estimation of the at least one characteristic curve, whereby the accuracy of the estimation is increased.

In addition or alternatively, the characteristic curve can be estimated supported by a model based on at least one value of the base characteristics. The characteristic curve can be estimated more rapidly and more accurately thereby, in an advantageous manner.

In addition or alternatively, the at least one characteristic can be estimated based on a windowed characteristic. The window time period can have a fixedly defined length or a variable length that is extended or abbreviated corresponding to the time span between the calculated contact time and the first point in time.

The at least one base characteristic from which the at least one characteristic is derived is provided, for instance, by at least one sensor unit. The base characteristic corresponds, for example, to an acceleration signal or a pressure signal, and the at least one characteristic corresponds to a first and/or second integral of the acceleration signal or the pressure signal.

### BRIEF DESCRIPTION OF THE DRAWINGS

An exemplary embodiment of the present invention is depicted in the figures and explained in greater detail below.

FIG. 1 shows a schematic block diagram of an example device for implementing an example method of the present invention.

FIG. 2 shows a more specific block diagram of a control unit from FIG. 1, to show the example method according to the present invention.

### DETAILED DESCRIPTION OF EXAMPLE EMBODIMENTS

In conventional methods, a calculated contact time is established by a point in time at which at least one specified condition is satisfied. For this case, a point in time at which the contact time is calculated, and the calculated contact point agree. Beginning at the calculated contact point, at least one characteristic is then calculated or derived, which is based on at least one sensor signal. In this manner of calculating, the period of time between the actual contact time and the calculated contact time is not taken into consideration for the calculation of the characteristics.

It is now provided, according to an example embodiment of the present invention, that, after an impact has taken place, one may calculate the contact time at a first point in time, and ascertain the curve of the at least one derived characteristic, in a time span between the calculated contact time and the first point in time, in retrospect.

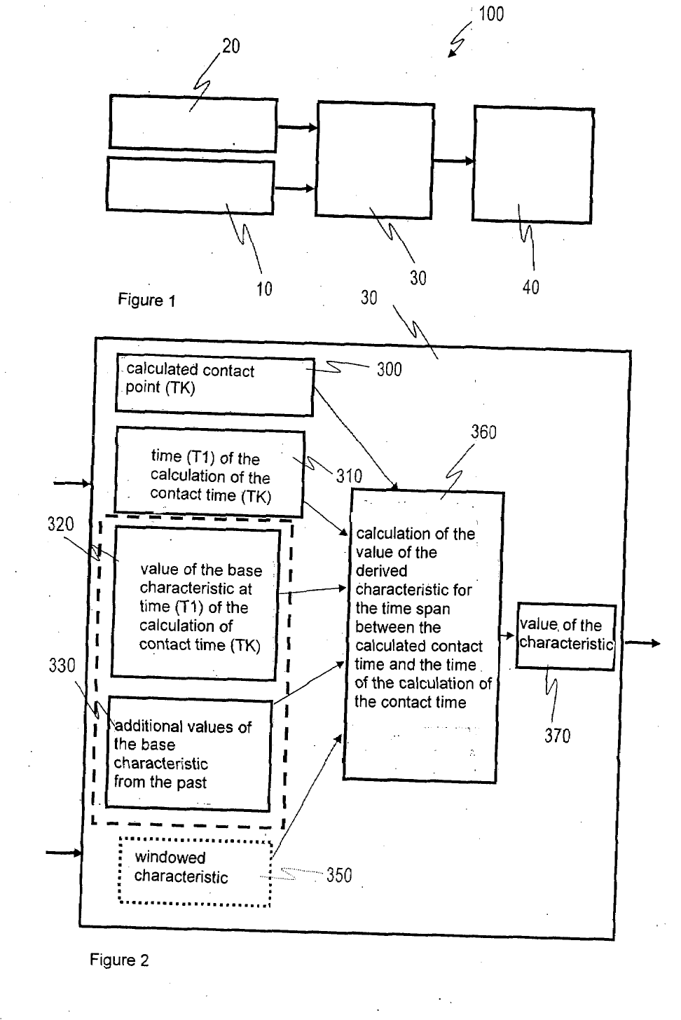

As can be seen in FIG. 1, an exemplary embodiment of a device 100, for estimating at least one characteristic, includes a first sensor unit 10 which includes, for example, an impact sensor designed as an acceleration sensor; a second sensor unit 20 which includes, for instance, remote acceleration sensors, pressure sensors etc.; a control unit 30 which receives various signals and base characteristics of the two sensor units 10, 20, in order, based on the sensor data made available, to determine the triggering decision for the appropriate passenger protection means 40, which include, for example, air bags, seat belt tensioners, etc.

FIG. 2 shows a more detailed block diagram of control unit 30, to show the sequence of the estimation of the at least one characteristic curve. The aim of the method, according to the present invention, is to estimate values or a curve of characteristics which are derived from values of base characteristics that are valid at the instantaneous point in time, or possibly from additional values of these base characteristics that refer to past points in time. Therefore, in block 300, after a contact or impact, a contact time TK is calculated, in block 310 the point in time of calculation T1 of the calculation of the contact time being recorded. In a first specific embodiment according to the present invention, in block 320, the value of a base characteristic is determined at time T1 of the calculation of contact time TK. The values determined in blocks 300 to 310 are made available to a block 360, which, using the values made available, calculates or estimates the value or the curve of the derived characteristic for time span Δt between the calculated, theoretical contact time and time T1 of the calculation of contact time TK.

If, for instance, the value of a first characteristic, e.g., a first integral, is known at time T1 at which contact time TK was calculated, and if the result of the calculation of contact time TK is available, then, according to the method according to the present invention, the curve of the first characteristic, that is, of the first integral, since calculated contact time TK is able to be ascertained or estimated, for instance, by assuming that the curve is a parabola. From the estimated curve of the first characteristic, or the first integral, the value of a second characteristic, e.g., a second integral, which is valid at time T1 of the calculation of contact time TK, can then also be ascertained.

In an additional specific embodiment according to the present invention, supported by a model, block 360 estimates the curve of the derived characteristic, the estimation also being able to be based on only one value of the base characteristic at time T1 of the calculation of contact time TK.

A further specific embodiment according to the present invention additionally, in block 330, determines further data for estimating the base characteristic, and makes this available to block 360 for estimating the derived characteristic. The additional data may include, for example, additional scanning values of the base characteristic, which include, for instance, all scanning values within an elapsed time span of a length that was previously established, for example, of 20 ms. This specific embodiment is represented by a dashed block that includes blocks 320 and 330.

An additional specific embodiment according to the present invention includes block 350 shown in a dotted line, which provides a windowed characteristic to block 360 for the approximation of the derived characteristic for estimating the derived characteristic. Block 350 may be present alternatively or in addition to blocks 320 and 330. Thus, for example, according to the above example, the value of the second integral since contact time TK, that is being sought, can be estimated by using a second window integral, which is calculated over a time period having a fixedly specified length. In this variant, the length of the window time period can optionally be designed to be variable, and can be extended or abbreviated, for instance, corresponding to the length of time span Δt, which has elapsed between calculated contact time TK and calculation point in time T1.

Further variants for estimating the value of the derived characteristic at time T1 of the calculation of contact time TK are also possible. Block 370 outputs the value or the estimated characteristic curve calculated in block 360. Subsequent methods, not shown, for generating triggering signals for passenger protection means 40, take into account the value of the output characteristic or the characteristic curve output in block 370 in ascertaining the triggering decision that is output by control unit 30 to passenger protection device 40.

1-11. (canceled)

12. A method for estimating at least one characteristic which is derived from at least one base characteristic and which is evaluated for the generation of a triggering signal for a passenger protection device, comprising:
calculating a theoretical contact time at a first time after an impact has occurred; and
ascertaining a curve of the at least one derived characteristic in retrospect in a time span between the calculated contact time and the first time.

13. The method as recited in claim 12, wherein the calculated contact time agrees with the actual contact time.

14. The method as recited in claim 12, wherein a value of the at least one base characteristic is taken into consideration at the first point in time for an estimation of the characteristic curve.

15. The method as recited in claim 14, wherein the characteristic curve is approximated by a parabola starting from a value of the at least one base characteristic at a time between the calculated contact time and the first time.

16. The method as recited in claim 14, wherein additional values of the at least one base characteristic from a specified elapsed time span is taken into consideration for the estimation of the characteristic curve.

17. The method as recited in claim 12, wherein the characteristic curve is estimated based on a model.

18. The method as recited in claim 12, wherein a windowed characteristic is used for estimating the at least one characteristic.

19. The method as recited in claim 18, wherein a window length of the windowed characteristic is extended or abbreviated corresponding to a time span between the calculated contact time and the first time.

20. The method as recited in claim 12, wherein the at least one base characteristic is made available by at least one sensor unit.

21. A device for estimating a characteristic, which is derived from at least one base characteristic and which is evaluated for generating a triggering signal for a passenger protection device, the device comprising:
a control unit which calculates a contact time at a first time after an impact has occurred, and ascertains in retrospect the curve of the at least one derived characteristic in a time span between the calculated contact time and the first time.

22. The device as recited in claim 21, further comprising:
at least one sensor unit adapted to make available to the control unit the at least one base characteristic.
